(19) United States
(12) Patent Application Publication
(10) Pub. No.: US 2003/0085074 A1
(43) Pub. Date: May 8, 2003

(54) Ladder step and platform

(76) Inventor: Terry Harmston, Blaine, MN (US)

Correspondence Address: JAMES R. CWAYNA, 8905 Wood Cliff Rd., Bloomington, MN, 55438, US

(21) Appl. No.: 10/046,682

(22) Filed: Jan. 16, 2002

Related U.S. Application Data
(60) Provisional application No. 60/259,936, filed on Jan. 8, 2001.

(51) Int. Cl. E06C 7/16

(52) U.S. Cl. 182/120

(57) ABSTRACT

A step and platform for use with a ladder which will allow a user to climb the ladder, using the ladder rungs, and, upon reaching a desired height at which the unit has been placed, swing the same into platform position. When in aligned position with the other rungs and stiles of the ladder, the rung thereof is available for normal climbing use and after ascending, the user may release the unit from aligned position to its support position and stand or place articles thereon.

The unit is easily inserted between adjacent rungs of a ladder and shifted to its operative position. A locking unit may be permanently affixed to the existing ladder or may be included with the ladder design.

The step and platform includes elements to engage the provided stiles and one rung of the ladder when in position on the ladder.

### PROVISIONAL APPLICATION REFERENCE

The subject matter of this invention and application was disclosed through the filing of a Provisional Application entitled Tree Ladder Step, Filed Jan. 8, 2001, Serial No. 60/259,936. Applicant has chosen to change the title of the application to Ladder Step and Platform as the invention is applicable to ladders of various types and will provide, in a first position, a platform upon which a user may stand or place articles and which will provide, in a second position, a rung corresponding to the other rungs of the ladder

### SPONSORSHIP

This invention was not made under the sponsorship of any third party including any Federal or Independent Sponsor and was made through the sole efforts of the named inventor.

### RELATED APPLICATIONS

Other than the above Provisional Application, applicant has not filed any previous applications pertinent to this subject matter and is not aware of any applications by third parties that are pertinent to the invention disclosed and claimed herein.

### FIELD OF THE INVENTION

This invention relates generally to a device for use with a ladder and more specifically to a step and platform that will, in a first position, be aligned with the rungs and stiles of a ladder of any design and which is shiftable from this first position to a second, outstanding position, to serve as a platform upon which the user of the ladder may stand or may place articles. The device is designed for removal from a ladder and easy placement into use position on a ladder of similar design.

### SHORT SUMMARY OF THE INVENTION

A step and platform for use with a ladder which will allow a user to climb the ladder, using the ladder rungs, and, upon reaching a desired height at which the unit has been placed, swing the same into platform position. When in aligned position with the other rungs and stiles of the ladder, the rung thereof is available for normal climbing use and after ascending, the user may release the unit from aligned position to its support position and stand or place articles thereon.

The unit is easily inserted between adjacent rungs of a ladder and shifted to its operative position. A locking unit may be permanently affixed to the existing ladder or may be included with the ladder design.

The step and platform includes elements to engage the provided stiles and one rung of the ladder when in position on the ladder.

### BACKGROUND AND OBJECTS OF THE INVENTION

There have been various platforms provided for ladders which usually include means for hooking the same over one rung or engaging the stiles of the ladder and resting upon another rung. These must be removed from the ladder to use the ladder in an ordinary manner.

Applicant's unit provides a combination step and platform that allows the ladder to be used in an ordinary manner which is to utilize the rungs to climb the same and by simply shifting the unit to a platform position will allow the user to either stand on the same or place articles thereon. Easily operated means for retaining the unit in closed or rung/stile alignment are provided which, upon actuation, allow the same to be swung from such aligned position to an outward support position.

The unit is easily placed into and easily removed from a ladder and could, if desired, be carried by the user to a desired location and inserted into the rung/stile arrangement of the same or similar ladder.

It is therefore an object of the applicant's invention to provide a ladder platform and step which is easily removed or inserted into the rung/stile design of a ladder without a positive attachment thereto.

It is a further object of the applicant's invention to provide a ladder platform and step which will not impede the normal rung use of the ladder but which is shiftable from a first non-use position to a second, load carrying position to support articles or the user thereon.

It is yet a further object of the applicant's invention to provide a ladder step and platform which is attachable to and removable from a ladder and which does not require any positive means for securing the same to the ladder.

It is still a further object of the applicant's invention to provide a ladder step and platform that engages a single rung and the stiles of a ladder for its connection thereto.

These and other objects and advantages of the applicant's invention will more fully appear from the accompanying drawings and disclosure.

### BRIEF DESCRIPTION OF THE DRAWINGS

FIG. 1 is a perspective view of a ladder step and platform embodying the concepts of the applicant's invention taken from below the step and platform;

FIG. 2 is a side view thereof illustrating, through the use of a dotted line, the shifting of the invention from a second to a first position;

FIG. 3 is a front elevation of the invention in aligned position with the rungs and stiles of the ladder or in what may be termed the closed or first position; and,

FIG. 4 is a side view of the invention taken substantially along Line 4-4 of FIG. 3.

### DESCRIPTION OF A PREFERRED EMBODIMENT OF THE INVENTION

In accordance with the accompanying drawings, a particular ladder 10 is illustrated. This ladder though specifically designed for scaling of trees, the configuration and use is generally the same as any other ladder in that it includes a pair of spaced stiles 11a, 11b and a plurality of spaced rungs 12 which are connected to and extend between the stiles. The stiles have a predetermined depth which is the dimension from front to back in the various Figures.

With the ladder 10 illustrated, the stiles 11a, 11b and rungs 12 are generally square in cross section and the ladder 10 is provided in sections such that the sections may be easily carried into a wooded area and thereafter assembled for the purpose of hunting. Means for joining sections includes a slip sleeve or hollow member 13 conforming to the square shape of the stiles 11a, 11b which is attached to the top of one of the stiles to receive the bottom of an upper stile therein. Standoffs 14, are also provided to maintain a predetermined spacing from a tree or other vertical member. Strap receiving ears 15 may be provided on the stiles 11a, 11b such that the ladder 10 may be secured to the tree or vertical member. The particular ladder illustrated is positioned close to a tree or vertical member and therefore the need for the standoffs 14 and ears 15.

The applicant has determined that, although useable with such a square stile and rung ladder, his invention is equally useable with ladders that include stiles and rungs of other shapes and the terminology of this disclosure should be considered to cover the same.

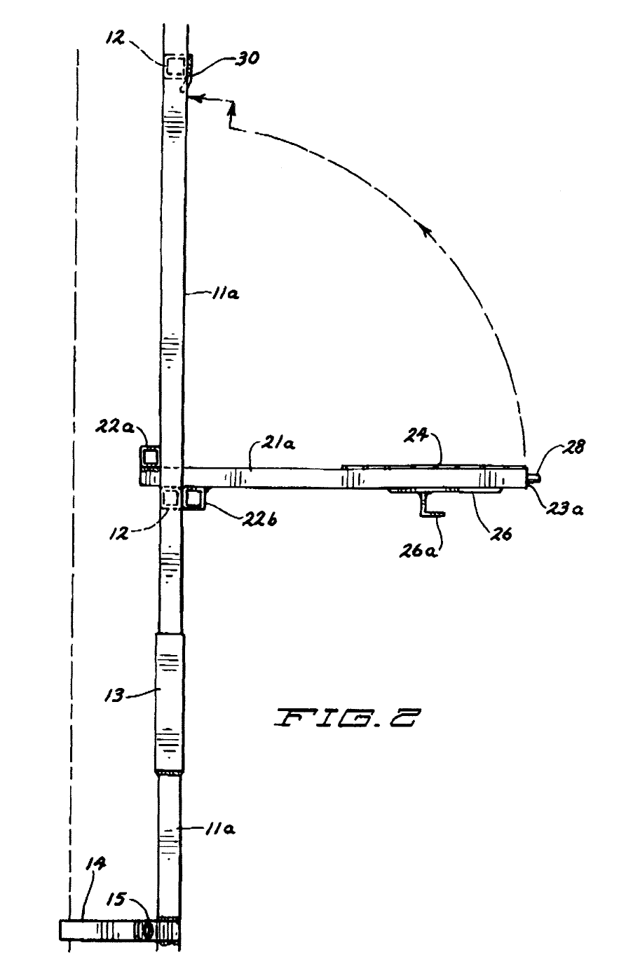

The step and platform is designated in its entirety 20 and includes a pair of longitudinally extending side members 21a, 21b which are laterally spaced such that the outboard dimension thereof will allow positioning and movement of the step and platform 20 between the spaced stiles 11a, 11b of a ladder 10, as illustrated in FIG. 2.

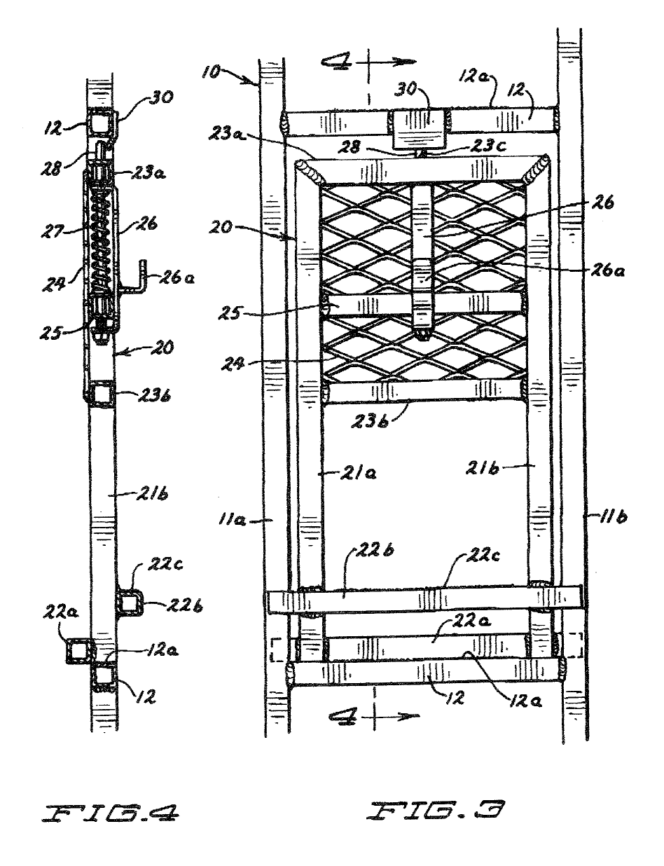

A first cross member 22a is arranged traversely to and secured to one side of side members 21a, 21b with its ends extending laterally therepast and is located at one end thereof. This cross member 22a, being longer than the width of the step or platform 20, will abut with the ladder stiles 11a, 11b and prevent movement therepast when in the aligned position, outward article supporting position and intermediate positions as indicated by the dotted line of FIG. 3.

A second cross member 22b is arranged transversely to and secured to the opposite side of side members 21a, 21b with, again, its ends extending laterally therepast and is located a spaced dimension from the one end thereof which spacing is determined such that a stile will be accommodated between such cross members 22a, 22b. This cross member 22b, again being longer than the width of the step or platform 20, will abut with the ladder stiles 11a, 11b and prevent movement therepast when in aligned, outward article supporting position and intermediate positions as indicated by the dotted line of FIG. 2.

When in the stile aligned position of FIGS. 3 and 4, cross member 22b will serve as a rung for the user.

All of the rungs 12 of the ladder may be provided with a non-slip member or coating 12a and member 22b may be provided with a similar member or coating 22c as this member 22b is in position to serve as a rung when the step or platform 20 is in the stile aligned position of FIGS. 3 and 4.

It should be noted that, as stated hereinabove, cross member 22a is arranged in close relation to the ends of the side members 21a, 21b of the step or platform 20 and the cross member 22b is arranged in spaced relation therefrom. The spacing between members 22a and 22b is such that a stile may be therebetween when the step and platform 20 is in either stile aligned or article supporting position as best shown in FIGS. 2 and 4.

The end of the step and platform 20 spaced from the cross bars 22a, 22b includes a pair of support members 23a, 23b secured to side members 21a, 21b and the upper surface thereof is covered with, in the form shown, an expanded metal member 24 for support of articles thereon.

In the form shown, means to lock the step and platform 20 in stile aligned position is provided below the support surface 24 and includes a first pin carrying cross bar 25 to carry a channel and rod actuating member 26 having an actuating handle 26a and containing a spring 27 and locking rod 28. Locking rod 28 extends through a passage 23c formed in cross bar 23a and a compatible passage through cross bar 25. Spring 27, lock rod 28 and channel, actuating member 26 are movable to cause extension and allow retraction of pin 28 into and out of a pin receiving element 30 provided on a rung 12 of the ladder 10. This element 30 may be an individual, mounted element or may simply be an aperture provided in such a rung 12. These locking elements 30 could be provided on all rungs of the ladder or selected rungs and if only an aperture is provided to receive pin 28, all rungs may be provided with such aperture.

As described, it should be obvious that the step or platform 20 is not attached to the ladder and therefore, it may be removed from the particular ladder and installed on another ladder having the same general rung and stile configuration and shapes. The entire step and platform will logically be manufactured from materials of the same or similar shape to a selected ladder.

In order that the step or platform 20 be easily installed and removed from a ladder, it is only necessary that the diagonal measurement between a pair of rungs and the pair of stiles to which the rungs are attached be greater than the effective length of the stile engaging cross members 21a, 21b. The step and platform 20 is simply oriented to this diagonal and inserted between rungs and stiles and thereafter rotated to bring the cross members 21a and 21b respectively in front of and behind the stiles as illustrated in all the Figures. The removal of the step or platform is accomplished in the reverse procedure.

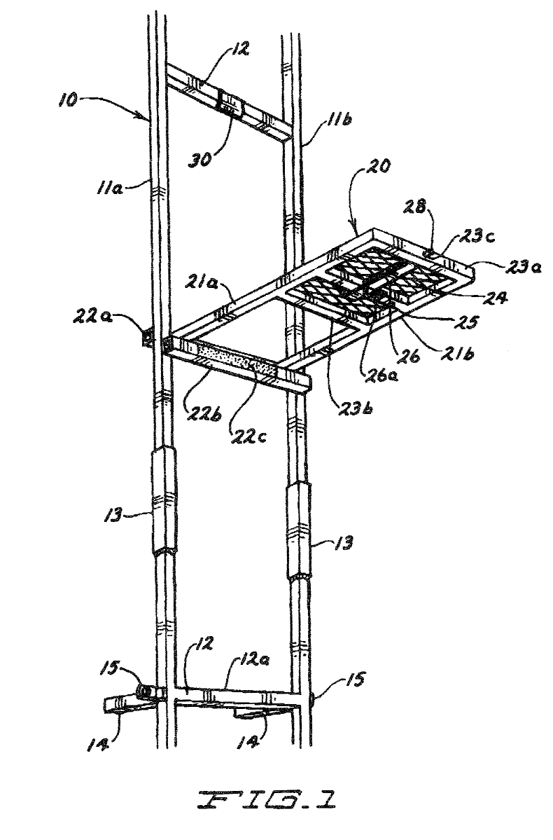

As stated, when in the closed or stile aligned configuration of FIGS. 3 and 4, a surface of cross member 22b will serve as a rung and a users upward mobility will not be affected. To bring the step or platform 20 into the article supporting position of FIGS. 1 and 2, pin 28 is retracted against spring 27 away from the lock element or rung aperture 30 and the step or platform 20 swung downwardly where the location of the cross members 22a, 22b will hold the same in an outwardly directed orientation.

When in the closed or stile aligned position, the actuating lever 26 is in a usable position and when the step or platform is in the article or stand upon position of FIGS. 1 and 2, the actuation lever 26a is below the same and will not hinder a person standing on the unit nor the placement of articles thereon.

In actual use, a user will normally climb to a rung above the location of the step and platform 20 and operate the same from above the same.

It should be obvious that the applicant has provided a new and unique step and platform arranged for removable positioning with respect to the rungs and stiles of a ladder to effectively allow use of the ladder in what may be termed a normal manner or in a loaded or user support manner.

What is claimed is:

1. A step and platform for use with a ladder which ladder is provided with a pair of laterally spaced stiles each having a depth and width and a plurality spaced climbing rungs, the step and platform including:
a. a pair of longitudinally extending, laterally spaced side members;
b. the spacing between said side members being determined such that the outermost surfaces thereof will lie between the stiles of the ladder;
c. a first transversely extending member attached to one side of and at one end of said side members;
d. a second transversely extending member attached to the other side of said side members and longitudinally spaced from said first member a distance to permit a stile to be positioned between said first member and itself; and,
e. the length of said first and second transversely extending members being determined to have the ends thereof extend outwardly past the outermost surfaces of said side members and greater than the lateral spacing of the ladder stiles whereby the step and platform may be positioned to have said sides adjacent one rung of the ladder with the stiles of the ladder positioned between said first and second extending members whereby the step and platform may be rotated with respect to the rung to shift the same from a second outwardly directed position to a first position of alignment with the ladder stiles.

2. The step and platform for use with a ladder as set forth in claim 1 and means for releasably locking the same to the next upper rung of the ladder to hold the step and platform in alignment with the stiles of the ladder.

3. The step and platform for use with a ladder as set forth in claim 2 wherein said locking means includes a retractable, spring loaded rod member arranged on the end of said extending side members opposite said first transversely arranged member.

4. The step and platform for use with a ladder as set forth in claim 3 and the rungs of said ladder being selectively provided with a rod receiving element.

5. The step and platform for use with a ladder as set forth in claim 3 and each of the ladder rungs being provided with a rod receiving aperture.

6. The step and platform for use with a ladder as set forth in claim 1 wherein the first and second transversely extending members are of a length lesser than the diagonal distance between a first rung of the ladder, a second rung of the ladder and the stiles of the ladder.

7. The step and platform for use with a ladder as set forth in claim 1 wherein the stiles and rungs of the ladder are of a determined cross sectional shape and at least the first and second transversely extending members of the step and ladder are of the same cross sectional shape.

8. The step and platform for use with a ladder as set forth in claim 1 and at least a portion of the laterally spaced side members having a load support member extending therebetween.
